(19) United States
(12) Patent Application Publication
(10) Pub. No.: US 2009/0326964 A1
(43) Pub. Date: Dec. 31, 2009

(54) EXTENSIBLE AGENT-BASED LICENSE STRUCTURE

(75) Inventors: Sanjay Garg, Redmond, WA (US); Scott Kurtzeborn, Redmond, WA (US); Qi Zhong, Redmond, WA (US); Gordon Hardy, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/145,552

(22) Filed: Jun. 25, 2008

(51) Int. Cl. G06Q 30/00; G06F 15/16; G06F 7/00; H04L 9/32; G06F 17/30

(52) U.S. Cl. 705/1; 709/202; 707/3; 726/29; 707/E17.014

(57) ABSTRACT

An extensible licensing system is described that allows modification of the way a product is licensed by third parties after the product has been released. The third party provides a licensing agent that includes a user interface that supplants the user interface for licensing provided by the application. The system invokes the third party licensing agent to obtain licensing information from the user. The system receives licensing information from the licensing agent and allows the application to function using the licensing information. Thus, a third party can create a seamless licensing experience where the user performs licensing steps for one or more applications through the third party's integrated user interface.

### BACKGROUND

The copyright infringement of software (also known as software piracy) refers to several practices that involve the unauthorized copying of computer software. Copyright infringement of this kind is extremely common in the United States, Mexico, China, Indonesia, Russia, Brazil, Zimbabwe, and several other parts of the world. Most countries have copyright laws that apply to software, but some countries enforce the laws better than others. As an example, the rate of copyright infringement of software in the Asia-Pacific region has been estimated at 53% for 2004. The Business Software Alliance estimates that in 2006, 82% of the PC software used in China was pirated.

Many software providers have turned to technology to solve the problem of software piracy. Product activation is a license validation procedure required by some proprietary computer software programs. Specifically, product activation refers to a method where a software application hashes hardware serial numbers and an ID number specific to the product's license (a product key) to generate a unique installation ID. This installation ID is sent to the manufacturer to verify the authenticity of the product key and to ensure that the product key is not being used for multiple installations. As an example, Microsoft first used product activation in some versions of Microsoft Office 2000. Some copies sold in Australia, Brazil, Canada, China, Hong Kong, New Zealand and the United States required the user to activate the product via the Internet. After its success, the product activation system was extended worldwide and incorporated into all subsequent versions of Windows and Office.

A non-activated product usually acts as a time-limited trial until a product key is purchased and used to activate the software. Alternatively, the product may provide a product key for a time-limited trial, so that the product can be activated from the start. Some products allow licenses to be transferred from one machine to another machine using online tools, without having to call technical support to deactivate the copy on the old machine before reactivating it on the new machine.

Software licensing systems, including product activation, typically include a fixed set of licensing schemes when the product is released. The licensing schemes may correspond to stock keeping units (SKUs) of a product. For example, Microsoft Office has offered SKUs including Standard, Professional, and Home and Student that include varying bundled applications. It is hard to enable any new licensing scenarios after a product releases. For example, users may request new types of licensing terms, such as subscription-based licensing, where the user pays for a period of use of one or more applications. As another example, a third party may want to include an application from another software provider with its own applications or service offerings. Unless the software provider is aware of these types of models when the product releases, adding support for them generally involves updating the product entirely. In addition, when a third party combines products from a software provider the user is often left with a more complicated licensing experience, because each application must be activated separately. Each application may provide its own user interface and steps for completing activation that the user must work through before using the products.

### SUMMARY

An extensible licensing system is described that allows modification of the way a product is licensed by third parties after the product has been released. The third party provides a licensing agent that includes a user interface that supplants the user interface for licensing provided by the application. When the system receives a request to run the application, the system determines whether the software application has a valid license. If the software application does not have a valid license, then the system invokes or notifies the third party licensing agent to obtain licensing information from the user. The system receives licensing information from the licensing agent and allows the application to function using the licensing information. The user can then use the application. Thus, a third party can create a seamless licensing experience where the user performs licensing steps for one or more applications through the third party's integrated user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the extensible licensing system and a typical environment, in one embodiment.

FIG. 2 is a flow diagram that illustrates the processing of the extensible licensing system to set up an application that provides third party licensing, in one embodiment.

FIG. 3 is a flow diagram that illustrates the processing of the extensible licensing system each time the licensable application runs, in one embodiment.

FIG. 4 is a flow diagram that illustrates the processing of the extensible licensing system to renew an expiring license, in one embodiment.

FIG. 5 is a flow diagram that illustrates the processing of the licensing agent to enable a third party to license the application, in one embodiment.

### DETAILED DESCRIPTION

An extensible licensing system is described that allows modification of the way a product is licensed, by either the software provider or third parties, after the product has been released. The extensible licensing system provides a platform through which a licensing agent can communicate with an application to perform licensing tasks through the licensing agent. The licensing agent may include a user interface that supplants the user interface for licensing provided by the application. The system first receives a request to run the application. For example, the user may launch the application. The system determines whether the software application has a valid license. For example, the system may search a certificate store for a certificate that includes a license for the application. If the software application does not have a valid license, then the system invokes or notifies the third party licensing agent to obtain licensing information from the user. For example, the third party licensing agent may direct the user to a website for submitting a payment for a time-based license (e.g., a subscription) for using the application. The system receives licensing information from the licensing agent, and allows the application to function using the licensing information. The user can then use the application. Thus, a third party can create a seamless licensing experience where the user performs licensing steps for one or more applications through the third party's integrated user interface.

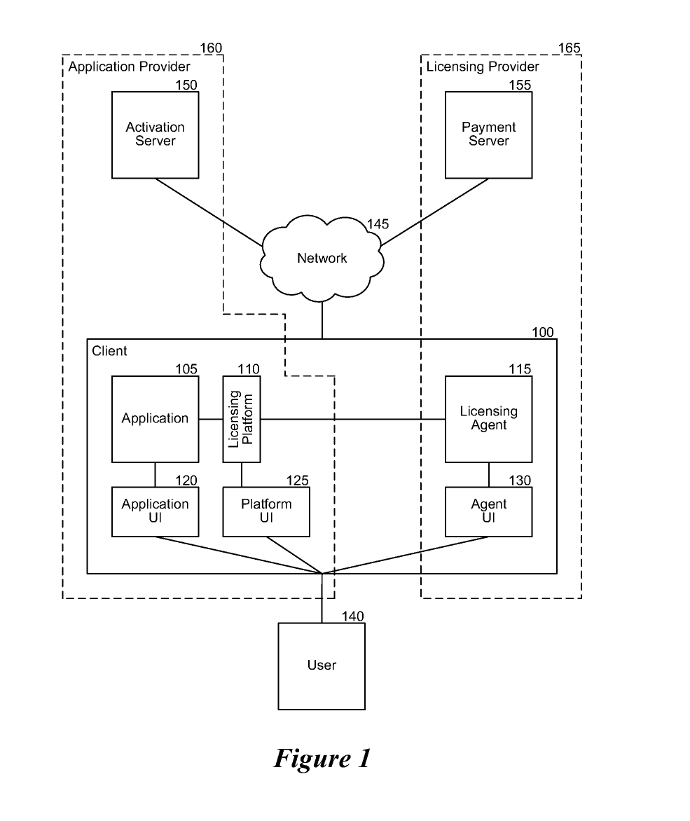

FIG. 1 is a block diagram that illustrates components of the extensible licensing system and a typical environment, in one embodiment. The system includes a client computer 100 that is connected through a network 145 (e.g., the Internet) to an activation server 150 and a payment server 155. A user 140 uses the client computer 100 to run applications. The client computer 100 includes an application 105, a licensing platform 110, a licensing agent 115, an application user interface 120, a licensing platform user interface 125, and a licensing agent user interface 130. The components within the box 160 are typically provided by the application provider and the components within the box 165 are typically provided by the licensing provider, which may be a third party. Each of these components is described in further detail herein.

The application 105 is a software application, and can include a wide variety of applications common in the art. The application 105 may include functionality to determine whether the application 105 is licensed. For example, the application 105 may include a public key for determining whether the application manufacturer or another authorized agent signed a product key provided to license the application 105. The application 105 may operate in a reduced functionality mode or not operate at all if the application 105 is not licensed. The application 105 may also provide a grace period for licensing the application 105 during which the user 140 can try out the application. The application user interface 120 provides the interface between the application 105 and the user 140.

The licensing platform 110 handles licensing the application and interacts with the licensing agent 115 to handle any third party licensing. The licensing platform user interface 125 includes a default licensing user interface in case no licensing agent user interface 130 is present and may include common dialogs and other user interface elements that the licensing agent 115 can request to use. For example, the licensing platform user interface 125 may include a dialog for entering a product key that users are familiar with, and even though a third party customizes other elements of the licensing process, he/she may still want to present the familiar product key dialog to the user.

The licensing platform 110 communicates with the activation server 150 to validate product keys and to obtain licensing certificates. The activation server 150 may request information from the licensing platform 110 about the hardware of the client 100 that can be used to identify the client. For example, the activation server 150 may collect a disk signature, processor serial number, and other identifying information about the client 100. This prevents a user from copying the activated software to another client and running the software as if it were properly licensed. The activation server 150 may track a usage count of each product key to determine if a product key is being misused (such as when a user posts it to a public forum for others to use). The activation server 150 receives from the payment server 155 or another server of the licensing provider a count of purchased licenses for each key that determine whether the key can be reactivated after a license certificate expires.

The licensing agent 115 allows third parties or the application provider to extend the licensing schemes without modifying the application 105. The licensing agent 115 also allows a third party to override the default licensing behavior and user interface of the licensing platform 110, and to provide custom replacements. The licensing agent user interface 130 provides a customized user interface for performing licensing functions and can be customized in any way desired by the licensing provider. For example, the licensing provider may unify the licensing of several products in one interface to simplify the licensing process for a bundle of applications provided by the licensing provider. The licensing agent 115 informs the licensing platform 110 of the parts of the licensing process that the licensing agent 115 overrides.

The licensing agent 115 communicates with a payment server 155 that receives payment from the user 140 or an administrator responsible for the client 100. The payment server 155 communicates with the activation server 150 to obtain product keys that identify the usage of the application 105 for which the client 100 is licensed. The payment server 155 provides the product key to the licensing agent 115, which can automatically license the application 105 using the licensing platform 110. The user 140 may also obtain product keys through a separate step (e.g., during checkout of an e-commerce website) and later enter the product key during the licensing process, through the licensing agent user interface 130.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

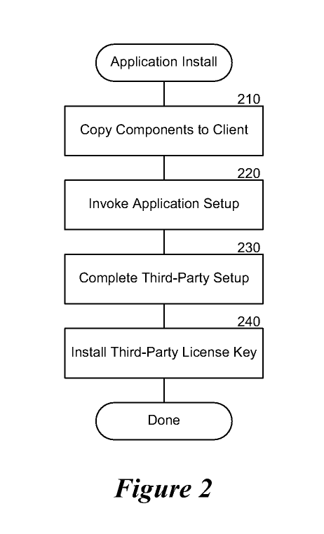

FIG. 2 is a flow diagram that illustrates the processing of the extensible licensing system to set up an application that provides third party licensing, in one embodiment. In block 210, the system copies components to the client computer of a user. For example, the third party may provide the user with a CD or a downloadable package from which the user invokes a third party setup program to perform installation. In block 220, the setup program invokes the application's setup program. For example, the third party setup program may launch a separate executable module provided by the application provider. The third party setup program may inform the application setup program (e.g., through a command-line switch) that the third party is handling licensing so that the application does not display any licensing related questions or instructions to the user. The third party setup program may install multiple applications in this way.

In block 230, after the application setup program completes, the third party setup performs any setup related tasks for the third party's applications or services. For example, the third party application may add a link to the third party's website to the user's desktop. In block 240, the third party setup program installs a license key that allows the application to function temporarily until product activation can take place. The key may include information that informs the application to defer to the third party licensing application for activating the application, so that the application does not display a licensing related user interface. The temporary key is generally cannot be used to activate the application with the activation server.

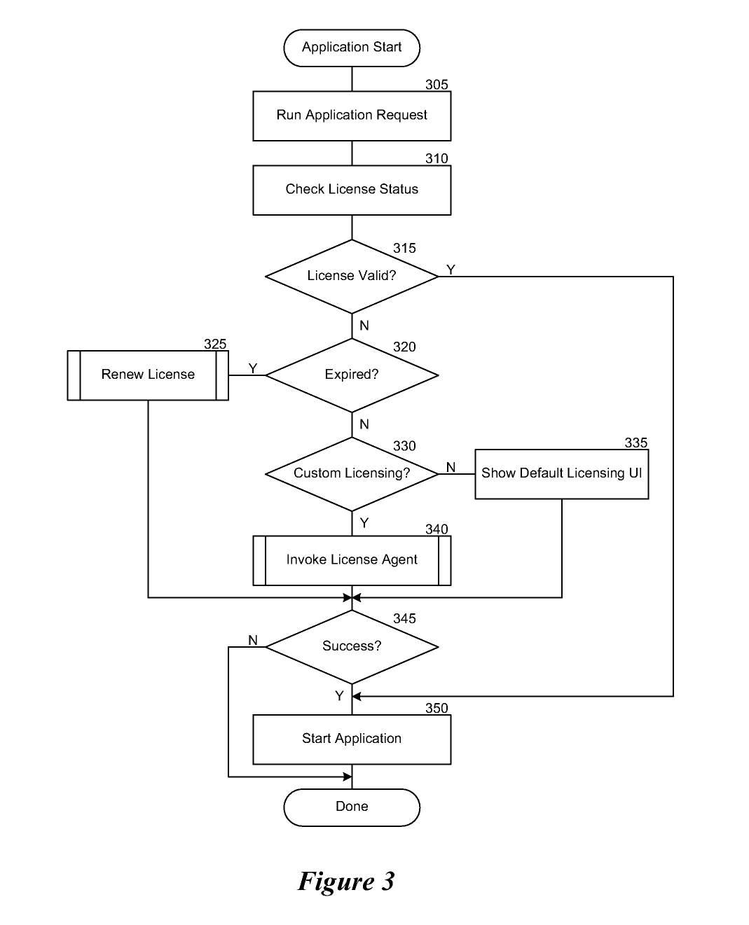

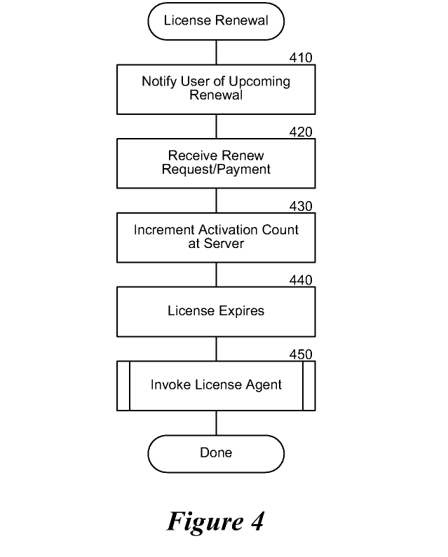

FIG. 3 is a flow diagram that illustrates the processing of the extensible licensing system each time the licensable application runs, in one embodiment. In block 305, the system receives a request to run the application. For example, the user may launch the application from a graphical desktop. In block 320, the application verifies the licensing status. For example, the application may inspect a registry setting related to licensing, a licensing file, a certificate store, or similar licensing storage to determine whether there is a valid licensing certificate installed. In decision block 315, if there is a valid license, then the system continues at block 350 and allows the application to run, else the system continues at block 320. In decision block 320, if the application has a valid license, but the license has expired, then the system continues at block 325 to renew the license (see FIG. 4), else the system continues at block 330.

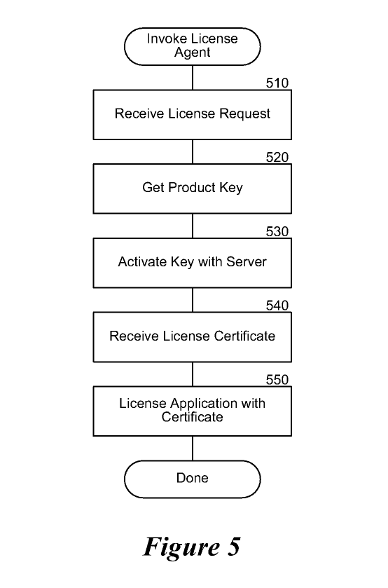

In decision block 330, if the system is not configured for custom licensing, then the system continues at block 335 and displays the default licensing user interface, else the system continues at block 340. For example, the product key installed with the application by the third party setup program may indicate that the application is in a third party licensing mode, even though no licensing has been performed at that point. In block 340, the system invokes or notifies the third party licensing agent to license the application (see FIG. 5). In decision block 345, if the licensing is successful, then the component continue at block 350, else the system completes and the application exits. In block 350, the system allows the application to run.

FIG. 4 is a flow diagram that illustrates the processing of the extensible licensing system to renew an expiring license, in one embodiment. Using the extensible licensing system, a user may license an application on a subscription basis (e.g., for six months), so that the license eventually expires. These steps are invoked when the license has expired or in some cases slightly before the license is about to expire (to give the user time to take action to renew before the application is disabled). In block 410, the system notifies the user of the upcoming expiration of the license. For example, the system may display a dialog box to the user, send the user an email, or display a notification in the user interface of the application that informs the user of how much time is left (e.g., 3 days) before the license expires.

In block 420, the system receives a request from the user to renew the license. For example, the user may browse to a web page maintained by the license provider and make a payment for an additional licensing term (e.g., six more months). In block 430, the payment server of the licensing provider informs the activation server that the user has paid for an additional term, and the activation server increments a count of available activations associated with the product key of the user. In block 440, the license expires. For example, the user may run the application and the application may detect that the term of the license has expired. In block 450, the system invokes or notifies the licensing agent to renew the license (see FIG. 5). If the renewal is successful, the licensing agent will receive a new certificate from the activation server for activating the application for the additional licensing term.

FIG. 5 is a flow diagram that illustrates the processing of the licensing agent to enable a third party to license the application, in one embodiment. These steps are invoked for initially licensing the application and for later renewals if the license expires. In block 510, the licensing agent receives a license request. For example, the licensing platform may inform the licensing agent that the application is not licensed by setting a registry key that the licensing agent monitors. In block 520, the licensing agent obtains a product key, either from the user or automatically, such as from the payment server. For example, the user may purchase a product key via a web page on the Internet and enter the product key in response to a prompt by the licensing agent.

In block 530, the licensing agent activates the key with the activation server. For example, the licensing agent may call an application-programming interface (API) in the licensing platform that transmits product keys and information about the calling client to the activation server. In block 540, the licensing agent receives a license certificate from the activation server. For example, the licensing platform may store the certificate in a certificate store and provide information about the certificate in response to the activation request of the licensing agent. In block 550, the licensing agent uses the received certificate to license the application. For example, the licensing agent may call another API within the licensing platform to complete licensing of the application using the received certificate. After the application is licensed, the system allows it to run and enables any functionality that was previously reduced. After block 550, these steps conclude.

The extensible licensing system can provide communication between the licensing platform and licensing agent in many different ways. For example, the licensing platform may set a registry key that informs the licensing agent when the application is unlicensed. The licensing agent can monitor the registry key and take appropriate action, such as displaying a licensing user interface, when the application is unlicensed. As another example, the system may use remote procedure calls (RPCs), named pipes, or any other method of communication between applications. In some embodiments, the extensible licensing system provides separate communication channels for multiple licensing agents. For example, a suite of applications may be licensed individually by different licensing agents and on different terms (e.g., one for three months and another for six months). If a registry key is used for communication, then the system provides a separate registry key for communication with each licensing agent or application.

Although time-based licenses are used as examples herein, the extensible licensing system can be used with many different types of licenses, including perpetual licenses. The licensing agent provides a uniform way of licensing applications that can be used whether the applications are to be licensed once or repeatedly. In addition, licenses may have varying levels of granularity. For example, a license may apply to a single application or a whole suite of applications (e.g., Microsoft Office), or to individual functions of an application (e.g., export to a proprietary file type). As described herein, the system may also provide an initial license for using the application in a trial mode or for providing a grace period during which the user can obtain a more extensive license using the licensing agent described. The system may also provide a grace period when the license expires if it is time-based, so that the user can continue using the application while obtaining a renewal license. The application may operate in a reduced functionality mode until the user obtains the more extensive license.

In some embodiments, the licensing certificates provided by the extensible licensing system contain attributes that affect the behavior of the application. For example, the certificate may include a set of bit flags that determine whether the licensing platform or the licensing agent is responsible for various user interface elements that are displayed during licensing. For example, the certificate may determine which component displays a dialog for entering product keys, an activation wizard, a hardware changed dialog prompting for reactivation, a clock-tampering dialog when clock tampering is detected, and so forth. The certificate may also contain a flag that indicates that third party licensing is active, so that the licensing platform will refer to the licensing agent for license-based decisions.

In some embodiments, the activation server charges the licensing provider for licenses as product keys are used. For example, the application provider may allow the licensing provider to issue product keys and accept payments from users, but not charge the licensing provider until a user uses the product key to activate an instance of the application. Alternatively or additionally, the application provider may sell units of keys (e.g., 100 at a time) to the licensing provider that the licensing provider sells to users. These and other methods of arranging payments between the application and licensing provider can be used by the system.

In some embodiments, the extensible licensing system displays information within the application to inform the user about the licensing state of the application. For example, the application may display a dialog that shows how many more days there are until the current license expires, whether the license is in a grace period, the suite that is licensed (e.g., Professional, Standard, Trial), and so forth. The application may also include branding for the licensing provider, including displaying a logo in the licensing information user interface or calling the licensing agent to display information within the application. For example, the application may co-brand the title bar of the application with the application's name and the licensing provider's name. From the foregoing, it will be appreciated that specific embodiments of the extensible licensing system have been described herein for purposes of illustration, but that various modifications may be made without deviating from the spirit and scope of the invention. For example, the extensible licensing system is compatible with many types of applications that benefit from an extensible license model. Accordingly, the invention is not limited except as by the appended claims.

I claim:

1. A computer-implemented method for licensing a software application, the method comprising:
receiving a request to run the software application;
determining whether the software application has a valid license, wherein a valid license can be obtained from an activation server;
if the software application does not have a valid license,
notifying a third party licensing agent to obtain licensing information;
receiving licensing information from the licensing agent; and
activating the software application using the licensing information, wherein the software application has a valid license after the software application is activated.

2. The method of claim 1 further comprising, if the software application has a valid license, running the software application.

3. The method of claim 1 further comprising, if the software application does not have a valid license, running the software application with reduced functionality.

4. The method of claim 1 further comprising, if the software application does not have a valid license, and if the request is received during a predetermined grace period, running the software application.

5. The method of claim 1 further comprising, if the software application does not have a valid license, determining whether to display a first licensing user interface provided by the software application or a second licensing user interface provided by the third party licensing agent.

6. The method of claim 1 wherein determining whether the software application has a valid license comprises searching a certificate store for a licensing certificate.

7. The method of claim 1 wherein determining whether the software application has a valid license comprises determining whether a time-based license has expired.

8. The method of claim 1 wherein invoking a third party licensing agent comprises setting a registry key that is monitored by the licensing agent, wherein the registry indicates that the software application does not have a valid license.

9. The method of claim 1 wherein activating the software application comprises sending a product key to the activation server and receiving a license certificate in response.

10. The method of claim 1 wherein receiving licensing information from the licensing agent comprises receiving a product key from a user through a user interface displayed by the licensing agent.

11. A computer system for providing third party licensing of an application, the system comprising:
an application configured to receive a license that determines whether application features are enabled;
a licensing platform configured to communicate with one or more licensing agents provided by one or more third parties other than the application provider;
an activation server configured to provide licenses in response to licensing requests; and
at least one licensing agent configured to communicate with a user of the application to obtain licensing information, send at least some of the information to the activation server, receive from the activation server a license, and provide the license to the application to enable the application features.

12. The system of claim 11 wherein at least some application features are enabled when the application has not received a license.

13. The system of claim 11 wherein the licensing platform communicates with licensing agents using RPC.

14. The system of claim 11 wherein the activation server receives a product key and information identifying the computer system and responds with a certificate containing the license.

15. The system of claim 14 wherein the certificate includes information identifying user interface elements related to licensing that are provided by the licensing agent.

16. The system of claim 11 further comprising a payment server configured to receive a payment from the user of the application and provide a product key to the user, and wherein the licensing information obtained from the user by the licensing agent includes the product key.

17. A computer-readable medium encoded with instructions for controlling a computer system to renew a time-based license for using software, by a method comprising:
notifying a user of the software that the time-based license is going to expire;
notifying a licensing agent separate from the software to obtain licensing information from the user;
receiving through the licensing agent a license renewal request from the user;
sending a request to an activation server to increase an available activation count associated with the user;
after the license expires, invoking the licensing agent to activate the software with the activation server and receive a new time-based license from the activation server.

18. The computer-readable medium of claim 17 wherein receiving the license renewal request from the user comprises displaying a user interface provided by the licensing agent.

19. The computer-readable medium of claim 17 wherein the license renewal request from the user includes a payment for renewing the time-based license.

20. The computer-readable medium of claim 17 further comprising displaying information in the software about the time-based license and the licensing agent.
